(19) United States
(12) Patent Application Publication
(10) Pub. No.: US 2011/0060847 A1
(43) Pub. Date: Mar. 10, 2011

(54) METHOD AND APPARATUS FOR TRANSPORTING AND INTEROPERATING TRANSITION MINIMIZED DIFFERENTIAL SIGNALING OVER DIFFERENTIAL SERIAL COMMUNICATION TRANSMITTERS

(75) Inventors: Nancy Chan, Richmond Hill (CA); Ramesh Senthinathan, Richmond Hill (CA)

(73) Assignee: ATI TECHNOLOGIES ULC, Markham (CA)

(21) Appl. No.: 12/944,501

(22) Filed: Nov. 11, 2010

Related U.S. Application Data
(62) Division of application No. 11/004,201, filed on Dec. 2, 2004, now abandoned.

(51) Int. Cl. G06F 3/00; G06F 13/42

(52) U.S. Cl. 710/10; 710/106

(57) ABSTRACT

A differential serial communication transmitter (i.e. PCI Express or other suitable type of transmitter) can be used to transport and interoperate transition minimized differential signaling. The differential serial communication transmitter control logic receives display configuration control data and in response configures at least one differential serial communication transmitter of a plurality of differential serial communication transmitters in an integrated circuit for communication with a display (i.e. visual digital display) employing transition minimized differential signaling. For example, the integrated circuit, such as a graphics processor, may include the plurality of differential serial communication transmitters for communication with devices, such as a northbridge circuit and a display within a computer system. The differential serial communication transmitter control logic may configure at least one of the plurality of differential serial communication transmitters for communication with the display via a differential serial communication display link (i.e. DVI or other suitable type of link). The plurality of differential serial communication transmitters may also be configured for communication with one or more other devices, such as with a bridge circuit such as a northbridge.

### RELATED CO-PENDING APPLICATIONS

This application is a divisional application of U.S. application Ser. No. 11/004,201 filed on Dec. 2, 2004, entitled “METHOD AND APPARATUS FOR TRANSPORTING AND INTEROPERATING TRANSITION MINIMIZED DIFFERENTIAL SIGNALING OVER DIFFERENTIAL SERIAL COMMUNICATION TRANSMITTERS”, having inventors Nancy Chan et al., owned by instant Assignee and is incorporated herein by reference and is related to application having docket number 00100.16.0030, filed on even date, entitled “METHOD AND APPARATUS FOR TRANSPORTING AND INTEROPERATING TRANSITION MINIMIZED DIFFERENTIAL SIGNALING OVER DIFFERENTIAL SERIAL COMMUNICATION TRANSMITTERS”, having inventors Nancy Chan et al., owned by instant Assignee and is incorporated herein by reference which is a continuation application of U.S. application Ser. No. 11/004,201 filed on Dec. 2, 2004, entitled “METHOD AND APPARATUS FOR TRANSPORTING AND INTEROPERATING TRANSITION MINIMIZED DIFFERENTIAL SIGNALING OVER DIFFERENTIAL SERIAL COMMUNICATION TRANSMITTERS”, having inventors Nancy Chan et al., owned by instant Assignee and is incorporated herein by reference.

### FIELD OF THE INVENTION

The invention relates generally to methods and an apparatus for differential serial communication, and more particularly for interoperating a differential serial communication with a computer graphics display, employing transition minimized differential signaling techniques.

### BACKGROUND OF THE INVENTION

Computer graphics displays typically interface with a graphics coprocessor via a digital visual interface (DVI) link. DVI links typically use transition minimized differential signaling (TMDS) for the base electrical interconnection. These DVI links are used to send pixel data, pixel clock and control signals from a graphics controller to a display device using TMDS. The transition minimization is achieved by implementing an 8b/10b-encoding algorithm. A single-link TMDS interface consists of three data channels and one clock channel. At a higher pixel bandwidth, a dual-link TMDS is employed, with six data channels and one clock channel. The TMDS interface may support a single DVI link at a pixel bandwidth of 1.65 Gbps. However, the TMDS interface faces the challenge of data rates exceeding 1.65 Gbps and the corresponding expense of a high-speed cable with the advent of higher-resolution display panels.

FIG. 1 illustrates a block diagram of the PCI Express (PCI-E) link architecture 100 including coprocessor 10 and a bridge circuit 12. The coprocessor 10 includes source data link 14, a data encoder 16, a phase-locked loop circuit 18 and a PCI-E transmitter 20. The bridge 12 includes a PCI-E receiver 22, a data decoder 24, a clock recovery circuit 26 and a phase-locked loop circuit 28.

The source data link 14 and the phase-locked loop circuit 18 receive a reference clock signal 30. In response to receiving the reference clock signal 30, the phase-locked loop circuit 18 produces a one-times clock signal 32 and a ten-times clock signal 34 as is known in the art. The source data link 14 provides packet data 36 to the data encoder 16. In response to receiving the packet data 36, the data encoder 16 transmits encoded packet data 38 to the PCI-E transmitter 20. The PCI-E transmitter 20 transmits serialized packet data 40 to the PCI-E receiver 22, as is known in the art.

The phase-locked loop circuit 28 produces different clock phases 42 to the clock recovery circuit 26. The clock recovery circuit 26 provides a recovered clock signal 54 to the data decoder 24. The PCI-E receiver 22 provides received packet data 44 to the data decoder 24. In response to receiving the packet data 44, the data decoder 24 provides decoded packet data 46 to an external I/O bus. The PCI-E transmitter 20 and the PCI-E receiver 22 are adapted to communicate clock recovery information in the packet data 40. For example, the clock recovery circuit 26 may recover the clock information from the packet data 40, as is known is the art.

The PCI-E link architecture 100 replaces the multiple similar parallel busses of the classic PCI bus architecture with PCI-E links with one or more lanes. Each link is individually configurable by adding more lanes so that additional bandwidth may be applied to those links where it is required, for example, in video graphics processing and bus bridges. The basic physical layer consists of dual unidirectional differential links that is implemented as a transmit pair and a receive pair of conductors. The PCI-E link architecture 100 supports a speed of 2.5 gigabits per second per lane per direction. The PCI-E link architecture 100 may support speeds of up to 10 giga transfers/second/direction. A PCI-E link may be linearly scaled by adding multiple lanes. The physical layer supports ×1, ×2, ×4, ×8, ×12 and ×32 lane widths. During initialization, each PCI-E link is configured in response to negotiation of lane widths and frequency of operation by the two agents at each end of the link. Further, during PCI-E initialization, the operating system may discover add-in hardware devices present and then allocate system resources, such as memory, I/O space and interrupts. The PCI-E standard uses an 8b/10b transmission code, identical to that specified in ANSI X3.230-1994. Computer DVI displays typically use DVI-type receivers. However, DVI-type transmitters cannot typically interoperate to drive a PCI-E-receiver.

### BRIEF DESCRIPTION OF THE DRAWINGS

The present invention is illustrated by way of example and not limitation in the accompanying figures, in which like reference numerals indicate similar elements and in which:

FIG. 1 is a prior art block diagram of a differential serial communication (i.e. PCI-E);

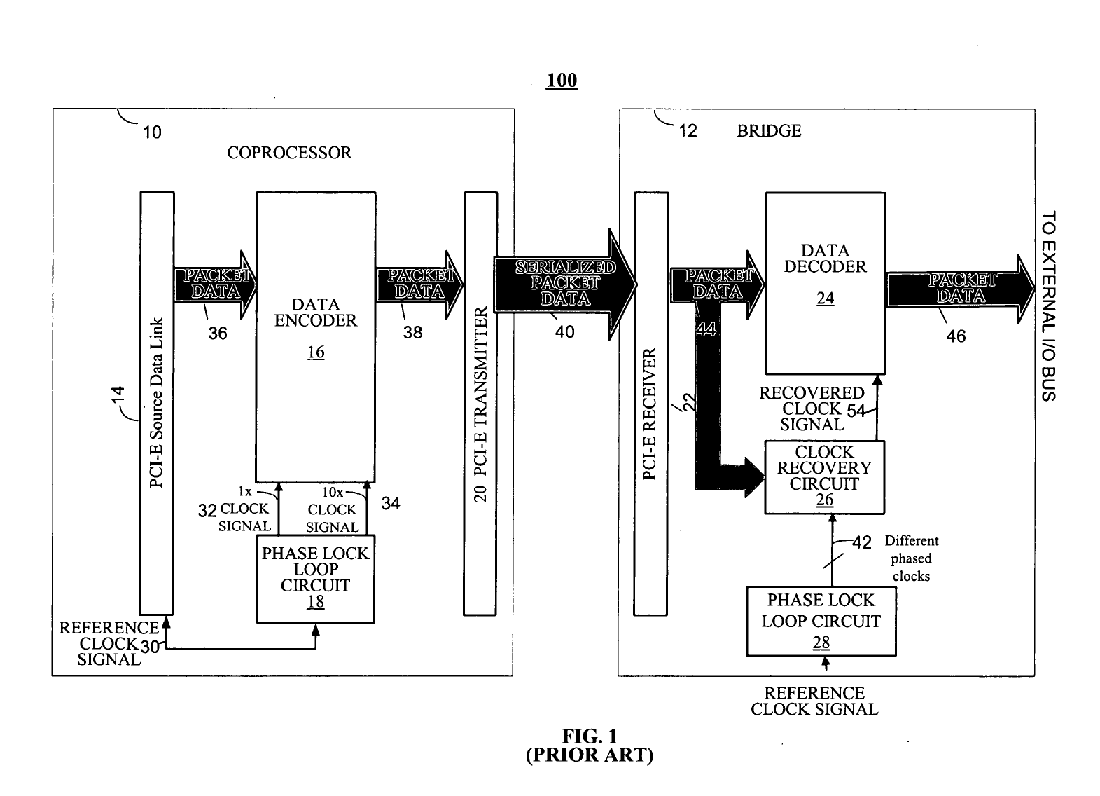

FIG. 2 is a prior art block diagram of differential serial communication display link (i.e. DVI);

FIG. 3 is a block diagram of a differential serial communication transmitter (i.e. PCI-E) configuration circuit according to one exemplary embodiment of the invention;

FIG. 4 is a block diagram of a differential serial communication transmitter (i.e. PCI-E) configuration system according to one embodiment of the invention;

FIG. 5 is a flowchart illustrating one example of a differential serial communication transmitter interoperability method according to one exemplary embodiment of the invention;

FIG. 6 illustrates the interoperability method of transportation of TMDS over a differential serial communication (i.e. PCI-E) transmitter circuit according to one exemplary embodiment of the invention; and

FIG. 7 is a flowchart illustrating one example of a differential serial communication (i.e. PCI-E) transmitter interoperability model according to another exemplary embodiment of the invention.

### DETAILED DESCRIPTION OF THE PREFERRED EMBODIMENTS

A differential serial communication transmitter control logic receives display configuration control data and in response configures at least one differential serial communication transmitter of a plurality of differential serial communication transmitters in an integrated circuit for communication with a display. For example, the integrated circuit, such as a graphics processor, may include the plurality of differential serial communication transmitters (i.e. PCI-E or other suitably type of transmitter) for communication with a bridge circuit and a display (i.e. DVI or other suitable interface) within a computer system. The differential serial communication transmitter control logic may configure at least one of the plurality of PCI-E transmitters for communication with the DVI display via a differential serial communication display link (i.e. DVI or other suitable interface). The plurality of PCI-E transmitters may also be configured for communication with one or more other bridge circuits, such as a northbridge.

Among other advantages, an integrated circuit, such as a graphics processor, includes a plurality of configurable differential serial communication transmitters for communication with any suitable external device, such as a graphics display, or a bridge circuit, such as a northbridge. As a result, the integrated circuit may be manufactured using a single type of configurable differential serial communication transmitter, such as PCI-E transmitters, rather than different types of differential serial communication transmitters, such as both PCI-E transmitters and TMDS transmitters. According to this embodiment, for example, since only a single type of differential serial communication transmitter is used to interoperate with the PCI-E bus and DVI interface, fewer differential serial communication transmitters are required to be allocated on the integrated circuit, thus saving valuable space and reducing the number of transistors used on the integrated circuit.

Further, since the plurality of differential serial communication transmitters may be configured for communication with a suitable device, fewer pins on the integrated circuit are required. In the situations where TMDS transmitters are required external to the integrated circuit, such external DVI-type transmitters and special pin allocations are no longer necessarily required. Additionally, since a single type of differential serial communication transmitter is utilized on the integrated circuit, different types of differential serial communication transmitters are not required. Yet another advantage may be realized by essentially standardizing the plurality of differential serial communication transmitters on an integrated circuit, so that, as improvements in data transfer rates and features that are developed for these standard interfaces, improvements to the differential serial communication transmitters on the integrated circuit are more readily implemented.

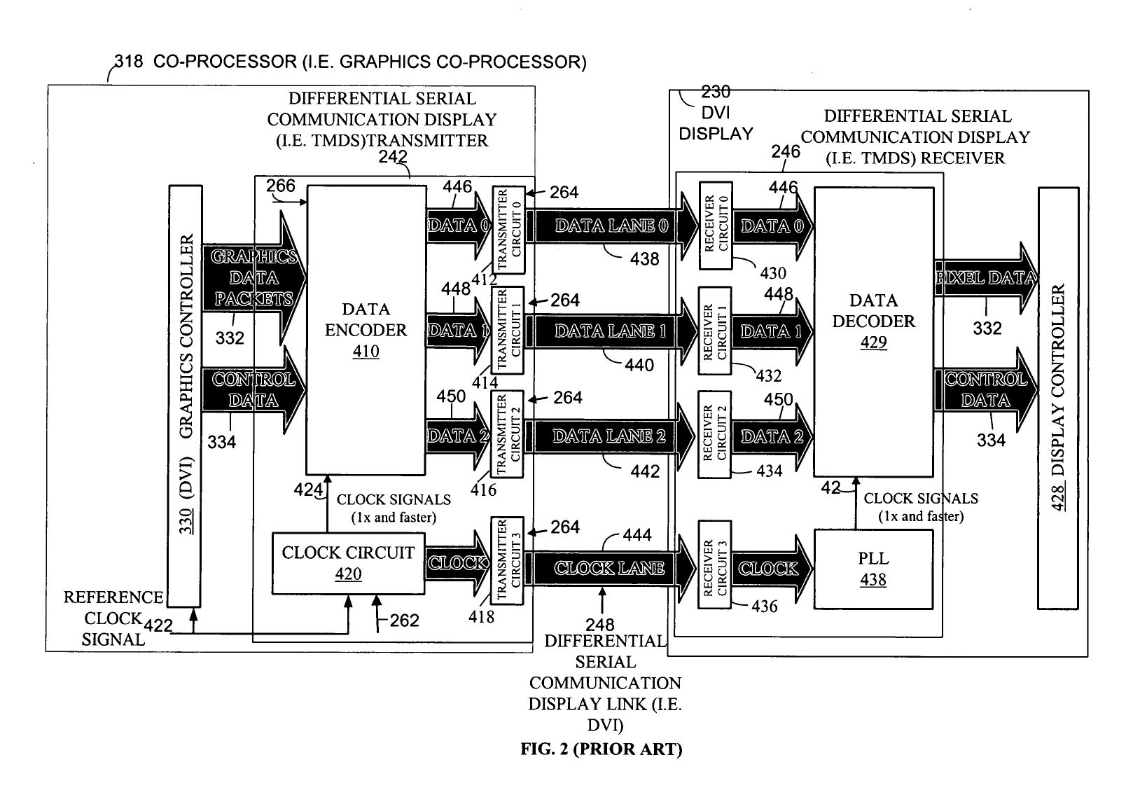

FIG. 2 is a block diagram of the coprocessor 318, the DVI display 230 and the differential serial communication display (i.e. DVI) link 248. The differential serial communication display (i.e. TMDS) transmitter 242 includes a data encoder 410, a transmitter zero circuit 412, a transmitter one circuit 414, a transmitter two circuit 416, a transmitter three circuit 418 and a clock circuit 420. The differential serial communication display (i.e. TMDS) receiver 246 includes the data decoder 429, a receiver zero circuit 430, a receiver one circuit 432, a receiver two circuit 434, a receiver three circuit 436 and a phase-locked loop circuit 438. Transmitter zero circuit 412, transmitter one circuit 414 and transmitter two circuit 416 provide data lane zero 438, data lane one 440 and data lane two 442 to receiver zero circuit 430, receiver one circuit 432 and receiver two circuit 434 respectively. The transmitter three circuit 264 provides clock lane 444 to receiver circuit 436. Receiver zero circuit 430, receiver one circuit 432 and receiver two circuit 434 provide data zero 446, data one 448 and data two 450 respectively to the data decoder 429.

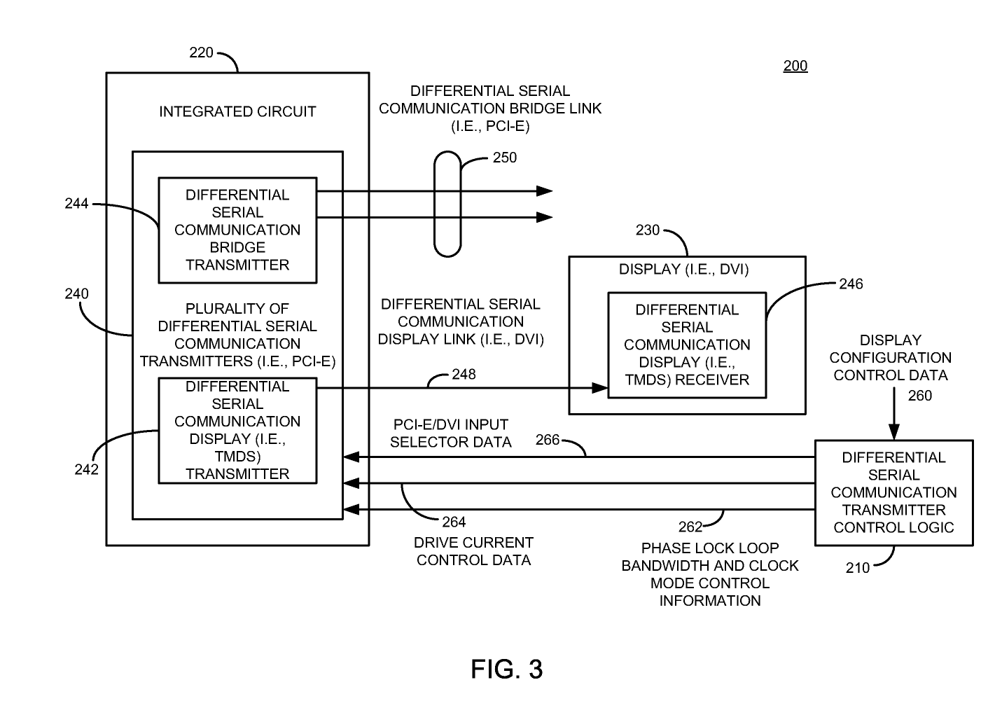

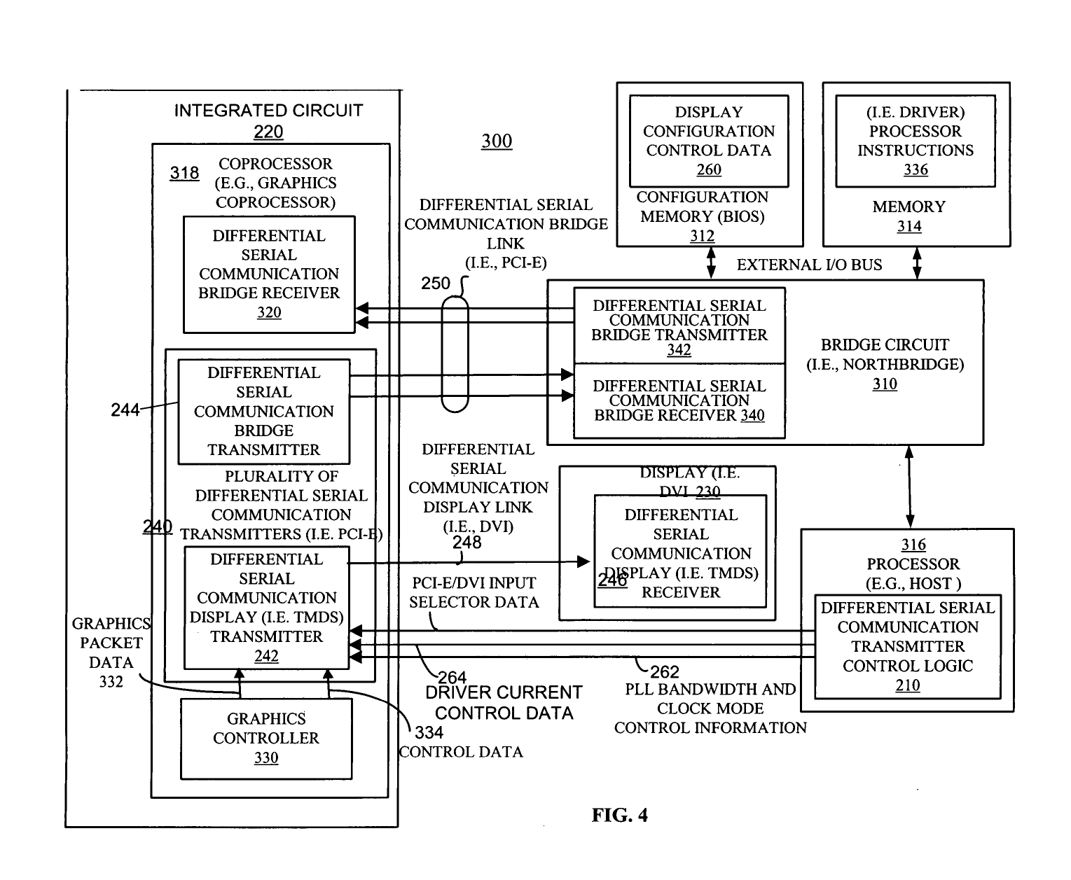

FIG. 3 is a block diagram of a differential serial communication transmitter configuration circuit 200 including a differential serial communication transmitter control logic 210, an integrated circuit 220 and a display (i.e. DVI) 230. The integrated circuit 220 includes a plurality of differential serial communication (i.e. PCI-E) transmitters 240 represented in block diagram form. The plurality of differential serial communication (i.e. PCI-E) transmitters 240 may be allocated as at least one differential serial communication display (i.e. TMDS) transmitter 242 and at least one differential serial communication bridge transmitter 244. The display (i.e. DVI) 230 includes a differential serial communication display (i.e. TMDS) receiver 246. The differential serial communication display (i.e. TMDS) transmitter 242 communicates with the differential serial communication display (i.e. TMDS) receiver 246 via a differential serial communication display (i.e. DVI) link 248. The differential serial communication bridge transmitter 244 communicates with a bridge circuit (shown as bridge circuit 310 in FIG. 4) via a differential serial communication bridge link (i.e. PCI-E) 250. The differential serial communication control logic 210 receives display configuration control data 260 and in response provides phase-locked loop bandwidth and clock mode control information 262, drive current control data 264 and PCI-E/DVI input selector data 266 to the differential serial communication display (i.e. TMDS) transmitter 242.

The differential serial communication transmitter control logic 210 may be one or more suitably programmed processors, such as a microprocessor, a microcontroller or a digital signal processor and, therefore, includes associated memory such as memory (312 and 314 shown in FIG. 4) that contains instructions that, when executed, cause the differential serial communication transmitter control logic 210 to carry out the operations described herein. In addition, the differential serial communication transmitter control logic 210, as used herein, includes discrete logic state machines or any other suitable combination of hardware, software and/or firmware.

The various elements of the differential serial communication transmitter configuration circuit 200 are linked by a plurality of links. The links may be any suitable mechanisms for conveying electrical signals or data, as appropriate. According to one embodiment, the interface between the differential serial communication display (i.e. TMDS) transmitter 242, the differential serial communication bridge transmitter 244, the differential serial communication transmitter control logic 210 and the differential serial communication display (i.e. TMDS) receiver 246 may be a host processor to graphics coprocessor interface, such as a PCI bus, an AGP bus, a PCI-E bus, an I²C (IC to IC) bus or any other suitable type of bus, either standardized or proprietary. Alternatively, theses interfaces may be integrated circuit interconnections within an application-specific integrated circuit (ASIC).

FIG. 4 illustrates one example of a differential serial communication transmitter configuration system 300, including a bridge circuit 310, configuration memory (e.g., BIOS) 312, memory 314 and a processor 316. The differential serial communication transmitter configuration system 300 is merely one example of a suitable system, and it will be recognized that any suitable apparatus or system may also carry out the operations and functions described herein. Although the differential serial communication bridge transmitter 244 and the differential serial communication display (i.e. TMDS) transmitter 242 are shown to communicate with, for example, a bridge circuit and a display (i.e. DVI) 230 respectively, the plurality of the differential serial communication (i.e. PCI-E) transmitters 240 may include, for example, the requisite differential drivers and other supporting logic to facilitate the communication of data to other appropriate differential receivers or to receive data from other appropriate differential transmitters. The various elements of the differential serial communication transmitter configuration system 300 are connected by a plurality of links. The links may be any suitable mechanisms for conveying electrical signals or data, as appropriate and as previously discussed.

The integrated circuit 220 is shown to include a coprocessor 318, which includes the plurality of differential serial communication (i.e. PCI-E) transmitters 240 (allocated between the differential serial communication display (i.e. TMDS) transmitter 242, and the differential serial communication bridge transmitter 244), as well as at least one differential serial communication bridge receiver 320.

The coprocessor 318 includes a plurality of differential serial communication transmitters 240, which includes, for example, the requisite differential transmit-and-receive drivers, compliant, for example, with the PCI-E specification, or any other suitable differential serial communication link. The graphics controller 330, provides graphics packet data 332 and control data 334 to the differential serial communication display (i.e. TMDS) transmitter 242. The coprocessor 318 may be a graphics coprocessor or any suitable graphics processor, including but not limited to the types sold and manufactured by ATI Technologies, Inc. of Thornhill, Ontario, Canada.

The bridge circuit 310 includes at least a differential serial communication bridge receiver 340 and a differential serial communication bridge transmitter 342. The bridge circuit 310 may be a northbridge or any suitable circuit as known in the art. The bridge circuit 310 may be suitably connected to the memory 314, configuration memory 312, processor 316 and coprocessor 318 through a suitable bus, such as a PCI-E bus or any bus suitable to other peripheral components. In addition, bridge circuit 310 and coprocessor 318 may also have a plurality of differential serial communication links, including one-way or bi-directional links coupled to other peripheral devices.

The memory 314 and the configuration memory 312 may be, for example, random access (RAM), read-only memory (ROM), optical memory or any suitable storage medium located locally or remotely, such as via a server or distributed memory, if desired. Additionally, the memory 314 and configuration memory 312 may be accessible by a wireless base station, switching system or any suitable network element via the Internet, a wide area network (WAN), a local area network (LAN), a wireless wide access network (WWAN), a wireless local area network (WLAN), such as but not limited to an IEEE 802.11 wireless network, a Bluetooth® network, an infrared communication network, a satellite communication network or any suitable communication interface or network. Memory 314 may be part of system memory, graphics memory, or any other suitable memory.

According to one embodiment, the differential serial communication transmitter configuration system 300 may be part of a computer system or other processor-based system. The computer system or other processor-based system may include a central processing unit, such as a processor 316, a coprocessor 318, such as the graphics video coprocessor, memory 314, such as system memory, configuration memory 312, such as BIOS memory, bridge circuit 310, such as a northbridge, and display 230. In such systems, the processor 316 functions as a loosely coupled coprocessor. By way of example, the coprocessor 318 may be an integrated circuit on a single semiconductor die, such as an application-specific integrated circuit (ASIC). Additionally, the coprocessor 318 may include memory (not shown), such as but not limited to dynamic random access memory (DRAM). This memory may reside on the same semiconductor die (e.g., ASIC) as the coprocessor 318 or it may be separate and connected through board-level or package-level traces.

The differential serial communication transmitter configuration system 300 is shown as a computing system, which may be, for example, incorporated in a hand-held device, laptop computer, desktop computer, server, or any other suitable device. The processor 316 may be one or more suitably programmed processors, such as a microprocessor, a microcontroller or a digital signal processor, and therefore includes associated memory, such as memory 314 and configuration memory 312, that contains executed instructions that, when executed, cause the differential serial communication transmitter control logic 210 to carry out the operations described herein.

According to the embodiment shown in FIG. 4, the differential serial communication transmitter control logic 210 is part of processor 316. For example, the differential serial communication transmitter control logic 210 is formed by the processor 316 receiving and executing processor instructions 336 stored in memory 314. The differential serial communication transmitter control logic 210 may be implemented in a software program, such as an application program or driver program, executing processor instructions 336 on processor 316 or any suitable processor. Alternatively, the differential serial communication transmitter control logic 210 may be part of the coprocessor 318.

In the embodiment shown in FIG. 4, the coprocessor 318 includes the differential serial communication bridge receiver 320, the differential serial bridge transmitter 244 and the differential serial communication display transmitter 242 as part of the integrated circuit 220 along with other circuitry, such as graphics processing circuitry. The coprocessor 318 is operably coupled to the differential serial communication bridge receiver 320, the differential serial bridge transmitter 244 and the differential serial display transmitter 242 through suitable circuitry and buses such as via a PCI-E link. According to the embodiment where coprocessor 318 is a graphics coprocessor, the coprocessor 318 may include for example, 2D and 3D rendering engines, video capture engines and any other suitable operations, as known in the art.

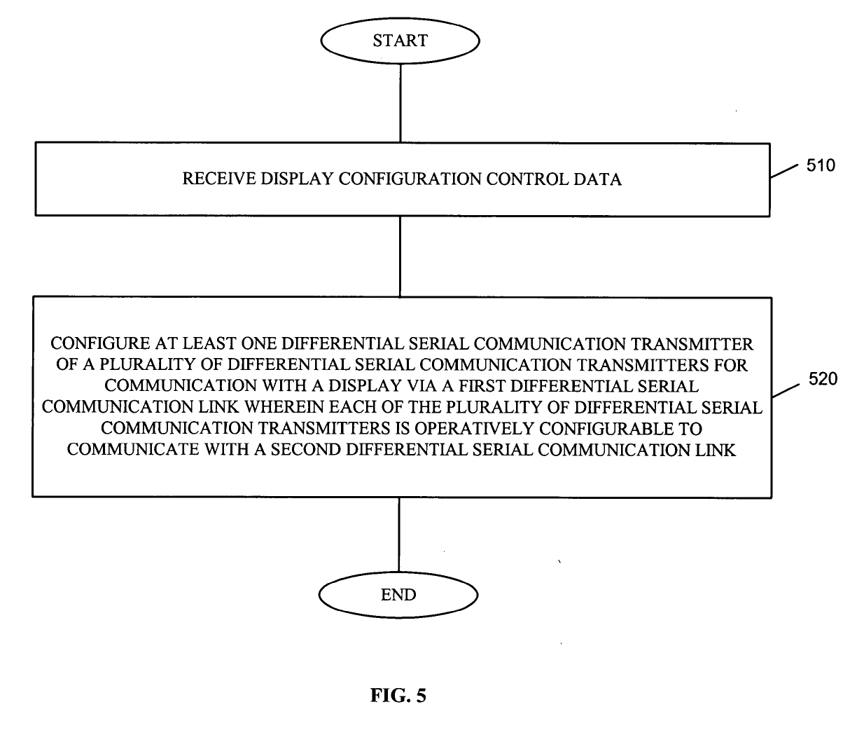

FIG. 5 is a differential serial communication (i.e. PCI-E) transmitter interoperability method in accordance with one exemplary embodiment of the invention. The method may be carried out by the differential serial communication transmitter control logic 210. However, any other suitable structure may also be used. It will be recognized that the method, beginning with step 510, will be described as a series of operations, but the operations may be performed in any suitable order and may be repeated in any suitable combination.

As shown in steps 510 and 520, the differential serial communication transmitter control logic 210 receives the display configuration control data 260 and, in response, configures at least one differential serial communication transmitter of the plurality of differential serial communication (i.e. PCI-E) transmitters 240 as differential serial communication display (i.e. TMDS) transmitter 242, for communication with the display (i.e. DVI) 230 via the differential serial communication display (i.e. DVI) link 248. As previously described, each of the plurality of differential serial communication transmitters (i.e. PCI-E) 240 are operably configurable to communicate with another differential serial communication link, such as the differential serial communication bridge link (i.e. PCI-E) 250.

According to one embodiment, such as, the embodiment shown in FIG. 4, the differential serial communication transmitter control logic 210 executes processor instructions 336 on processor 316. According to this embodiment, the differential serial communication transmitter control logic 210 receives the display configuration control data 260 from the configuration memory 312 during initialization, as is known in the art Therefore, according to this embodiment, the differential serial communication transmitter control logic 210 configures the differential serial communication display (i.e. TMDS) transmitter 242 during initialization.

According to one embodiment the differential serial communication transmitter control logic 210 configures the differential serial communication display (i.e. TMDS) transmitter 242, the transmitter zero circuit 412, transmitter one circuit 414, transmitter two circuit 416 and transmitter three circuit 418 to form the data lane zero 438, the data lane one 440, the data lane two 442 and the clock lane 444, respectively.

Alternatively, the differential serial communication display (i.e. TMDS) transmitter 242 may be configured with six transmitter circuits to provide six data lanes, or any other suitable number of transmitter circuits as required by the differential serial communication display receiver 246, within display 230. According to one embodiment, the differential serial communication display receiver 246 is a DVI-compliant receiver. The number of desired lanes may be determined by the differential serial communication transmitter control logic 210 operating as a driver executing on the processor 316. For example, the display configuration control data 260 stored in the configuration memory 312 may indicate the type of display (i.e. DVI) 230 in the computer system and may also indicate the number of receiver circuits, such as receiver zero circuit 430, receiver one circuit 432 and receiver two circuit 434, within the differential serial communication display (i.e. TMDS) receiver 246. In one embodiment, a link width command register and link width control register are integrated within the coprocessor 318 to set the link to the proper width size. Such command can be executed during initiation, a conventional reset or power-on condition.

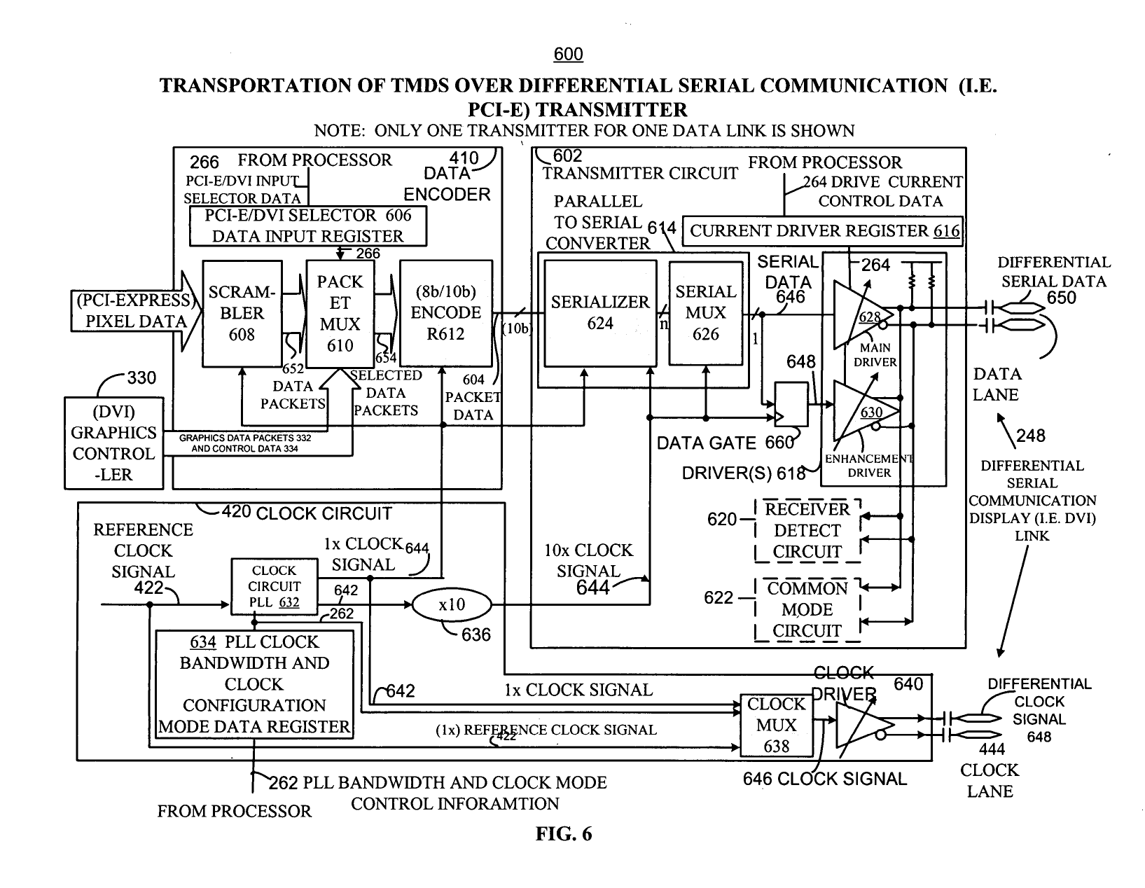

FIG. 6 is a block diagram of the transportation method of TMDS over a differential serial communication (i.e. PCI-E) transmitter circuit 600. For example, the transmitter circuit 602 may represent any of the transmitter circuits 412, 414, 416, 418 or any suitable transmitter. According to one embodiment, the data encoder 410 provides the requisite packet data 604 to the appropriate corresponding transmitter circuit 602. Although only one transmitter circuit 602 is shown, any number of transmitter circuits may be included in order to support any required number of data lanes, such as three or six data lanes and the clock lane 44. For example, a single link DVI, employs three data channels and one clock channel, as shown in FIG. 2. Accordingly, processor 316 provides the appropriate phase-locked loop bandwidth and clock mode control information 262, drive current control data 264 and PCI-E/DVI input selector data and configures the suitable number of transmitter circuits 602, such as transmitter zero circuit 412, transmitter one circuit 414, transmitter two circuit 416 and transmitter three circuit 418. A dual link DVI employs six data channels and one clock channel. Accordingly, the differential serial communication control logic 210 configures the suitable number of transmitter circuit 602 in order to provide seven transmitter circuits for supporting six data lanes and one clock lane.

The data encoder 410 includes a PCI-E/DVI selector data input register 606, a scrambler circuit 608, a packet multiplexor 610, and a data encoder 612. The transmitter circuit 602 includes a parallel to serial converter 614, a current drive register 616, at least one driver(s) 618, a receiver detect circuit 620 and a common mode circuit 622. The parallel to serial converter 614 further includes a serializer 624 and a serial multiplexor 626. The at least one driver/driver(s) 618 further includes a main driver 628 and an enhancement driver 630. The clock circuit 420 includes a phase-locked loop circuit 632, a phase-locked loop clock bandwidth and clock mode configuration data register 634, a ten-times multiplier 636, a clock multiplexor 638 and a clock driver 640.

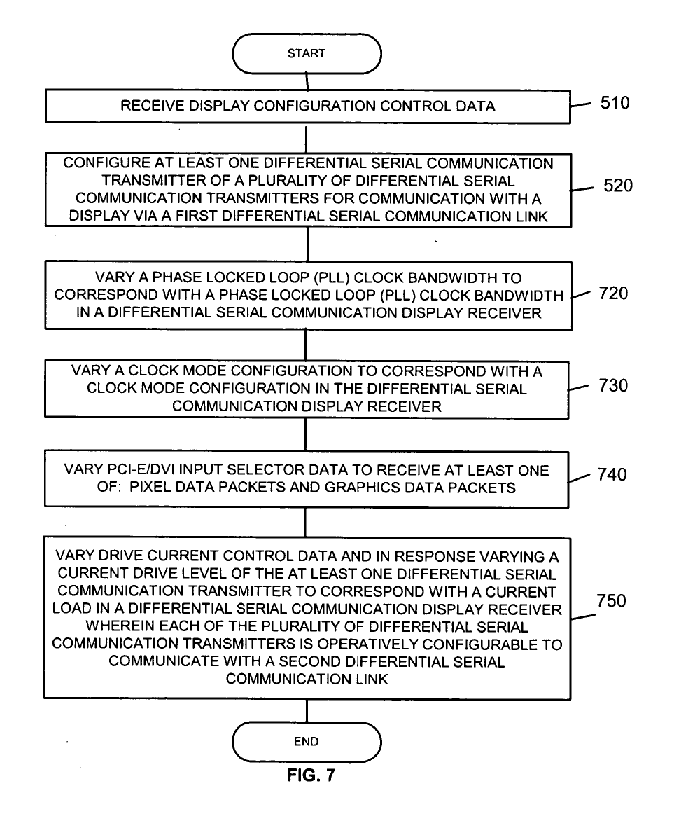

FIG. 7 illustrates the method of FIG. 5 in more detail. As shown in steps 720 and 730, the phase-locked loop clock bandwidth and clock mode configuration data register 634 receives phase-locked loop clock bandwidth and in response provides the phase-locked loop clock bandwidth and clock mode 262 the phase-locked loop clock circuit 632 and the clock multiplexor 638. For example, the phase-locked loop clock circuit 632 in response to receiving the phase-locked loop clock bandwidth and clock mode control information 262 varies a phase-locked loop clock bandwidth of the phase-locked loop clock circuit 632. According to one embodiment, the phase-locked loop clock circuit 632 may set the loop bandwidth between four megahertz±twenty percent, and other programmable bandwidth, depending on the clock mode configuration and its operation (i.e. DVI or PCI-E). The phase-locked loop clock circuit 632, in response to receiving the reference clock signal 422, generates a one-times clock signal 642. The phase-locked loop clock circuit 632 provides the one-times signal 642 to the scrambler 608, packet multiplexor 610, (8b/10b) encoder 612, the serializer 624 and the clock multiplexor 638. The phase-locked loop clock circuit 632 also provides the one-times clock signal 642 to the ten-times multiplier 636, and in response the ten-times multiplier 636 provides a ten-times clock signal 644 to the serializer 624.

As shown in step 730, the clock multiplexor 638 receives the reference clock signal 422. In response to the phase-locked loop clock bandwidth and clock mode control information 262, the clock multiplexor 638 selects either the one-time clock signal 642 from the output of the phase-locked loop clock circuit 632 or the (one-time) reference clock signal 422. As understood by one skilled in the art, the selection of the clock signal 646 based on the output of the clock phase-locked loop circuit 632, which produces the one-time clock signal 642 used in the data encoder 410 and the transmitter 602, will cause the phase of the differential clock signal 648 and the differential serial data 650 to be in phase. In contrast, if the clock multiplexor 638 generates the clock signal 646 based on the (one-time) reference clock signal 422, then the differential clock signal 648 and the differential serial data 650 will not be in phase. Depending on clock mode configuration required by the differential serial communication display (ie. TMDS) receiver 246, the clock multiplexor 638 generates the clock signal accordingly. Clock driver 640, in response to receiving the clock signal 646, generates a differential clock signal 648.

As shown in step 740, PCI-E/DVI data input register 606 receives the PCI-E/DVI input data 266 from the processor 316, and in response provides the PCI-E/DVI input selector data 266 to the packet multiplexor 610. In response to receiving the PCI-E/DVI input selector data 266, the packet multiplexor 610 selects either the graphics data packets 332 and control data 334 from the graphics control 330 or data packet 652 from the scrambler 608. For example, when the differential serial communication (i.e. PCI-E) transmitter is configured to communicate with the bridge circuit 310, the PCI-E/DVI input selector data 266 may cause the packet multiplexor 610 to produce selected data packets 654 based on the data packet 652. However, if the differential serial communication (i.e. PCI-E) transmitter is configured to communicate with the differential serial communication display (i.e. TMDS) receiver 246, then the PCI-E/DVI input selector data 266 may cause the packet multiplexor 610 to generate the selected data packets 654 based on the graphics data packets 632 and the control data 334.

As shown in step 750, in response to receiving the drive current control data 264 from processor 316, the current driver register 616 provides the drive current control data 264 to at least one driver 618, including the main driver 628 and the enhancement driver 630. For example, when the driver(s) 618 are coupled to the differential serial communication display (i.e. TMDS) receiver 246 via the differential serial communication display (i.e. DVI) 248, the driver current control data 264 may indicate the driver current required by the driver 618 to provide sufficient drive current to the differential serial communication display (i.e. TMDS) receiver 246. Accordingly, the processor 316 varies the drive current control data 264 to correspond with a current load in the differential serial communication display (i.e. TMDS) receiver 246. According to one embodiment, the drive current control data 264 controls the main driver 628 and/or the enhancement driver 630 in order to provide pre-emphasis to develop a low-voltage differential signal as is known in the art.

As understood by one skilled in the art, a data gate 660 receives the ten-times clock signal 644 and the serial data 646, and in response provides gated serial data 648 to the enhancement driver 630. Accordingly, the data gate 660 may gate the serial data 646 so that the enhancement driver 630 provides enhanced current output driving capabilities synchronous with the serial data 646, in order to provide enhanced current drive capabilities

Among other advantages, the integrated circuit 220, such as a graphics processor, includes a plurality of configurable differential serial communication transmitters 240 for communication with any suitable external device, such as a DVI graphics display 230 or the bridge circuit 310, such as a northbridge. As a result, the integrated circuit 220 may be manufactured using a single type of configurable differential serial communication transmitter, such as PCI-E transmitters, rather than different types of differential serial communication transmitters, such as both PCI-E transmitters and TMDS transmitters. Accordingly, since only a single type of differential serial communication transmitter may be used in the integrated circuit 220, fewer differential serial communication transmitters are required to be allocated on the integrated circuit 220, thus saving valuable space and reducing the number of transistors used on the integrated circuit.

Further, since the plurality of differential serial communication (i.e. PCI-E) transmitters 240 may be configured for communication with any suitable device, fewer pins on the integrated circuit 220 are required, since a different type of differential serial communication transmitter is not required. Therefore, special pin allocations on the integrated circuit 220 for multiple types of differential serial communication transmitters are not required. Further, in the situations where external TMDS transmitters are required external to the integrated circuit 220, such external DVI-type transmitters, are no longer necessarily mounted externally to the integrated circuit 220, as may be the case. Additionally, since a single type of differential serial communication transmitter is utilized on the integrated circuit 220, different types of differential serial communication transmitters are not required. Yet another advantage may be realized by essentially standardizing the plurality of differential serial communication transmitters on the integrated circuit so that, as improvements in data transfer rates and features that are developed for these standard type interfaces, improvements to plurality of the differential serial communication transmitters 240 on the integrated circuit 220 are more readily implemented.

It is understood that the implementation of other variations and modifications of the present invention and its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

We claim:

1. A differential serial communication transmitter configuration circuit, operative to configure a plurality of differential serial communication transmitters in an integrated circuit, comprising:
differential serial communication transmitter control logic, operative to receive display configuration control data, and in response, to configure at least one differential serial communication transmitter of the plurality of differential serial communication transmitters for communication with a display via a first differential serial communication link, and wherein the differential serial communication transmitter control logic is operative, in response to the received display configuration control data, to:
configure at least three of the plurality of differential serial communication transmitters to form three corresponding data lanes for communication with the display via the first differential serial communication link;
configure at least one of the plurality of differential serial communication transmitters to form a corresponding clock lane for communication with the display via the first differential serial communication link; and
wherein each of the plurality of differential serial communication transmitters is operatively configurable to communicate with a second differential serial communication link.

2. A differential serial communication transmitter configuration circuit, operative to configure a plurality of differential serial communication transmitters in an integrated circuit, comprising:
differential serial communication transmitter control logic, operative to receive display configuration control data, and in response, to configure at least one differential serial communication transmitter of the plurality of differential serial communication transmitters for communication with a display via a first differential serial communication link, and wherein the differential serial communication transmitter control logic is operative, in response to the received display configuration control data, to:
configure at least six of the plurality of differential serial communication transmitters to form six corresponding data lanes for communication with the display via the first differential serial communication link; and
configure at least one of the plurality of differential serial communication transmitters to form a corresponding clock lane for communication with the display via the first differential serial communication link; and
wherein each of the plurality of differential serial communication transmitters is operatively configurable to communicate with a second differential serial communication link.

3. A differential serial communication transmitter configuration system operative to configure a plurality of differential serial communication transmitters in an integrated circuit, comprising:
memory containing instructions executable by one or more processors that cause the one or more processors, to receive display configuration control data, and in response to configure at least one differential serial communication transmitter of the plurality of differential serial communication transmitters for communication with a display via a first differential serial communication link to:
vary a phase-locked loop (PLL) clock bandwidth to correspond with a phase-lock loop (PLL) clock bandwidth in a differential serial communication display receiver operatively coupled to the at least one differential serial communication transmitter;
vary a clock mode configuration to correspond with a clock mode configuration in the differential serial communication display receiver;
vary a PCI-E/DVI input selector data to receive at least one of: data packets and graphics data packets; and
vary drive current control data and in response vary a current drive level of the at least one differential serial communication transmitter to correspond with a current load in the differential serial communication display receiver,
wherein each of the plurality of differential serial communication transmitters is operatively configurable to communicate with a second differential serial communication link.

4. The differential serial communication transmitter configuration system of claim 3 further including:
a graphics processor, wherein the graphics processor includes the plurality of differential serial communication transmitters in the integrated circuit, the graphics processor including:
a phase-lock loop clock bandwidth and clock mode configuration data register, operatively coupled to the processor, and operative to receive phase-locked loop bandwidth control information and clock mode control information from the one or more processors;
a PCI-E/DVI input selector data register, operatively coupled to the differential serial communication control logic, and operative to receive PCI-E/DVI input selector data from the one or more processors; and
a driver-current control data register, operatively coupled to the processor, and operative to receive driver current control data from the processor.

5. A differential serial communication transmitter configuration system, including:
a graphics processor including:
a plurality of differential serial communication transmitters, wherein each of the plurality of differential serial communication transmitters is operatively configurable to communicate with a first differential serial communication link;
memory containing instructions executable by one or more processors that cause the one or more processors to receive display configuration control data and, in response, to configure at least one differential serial communication transmitter of the plurality of differential serial communication transmitters for communication with a display (i.e. DVI) via a second differential serial communication link.

6. The differential serial communication transmitter configuration system of claim 5, including:
a display including:
at least one differential serial communication receiver operatively coupled to the at least one of the plurality of differential serial communication transmitters via the second differential serial communication display link.

7. The differential serial communication transmitter configuration system of claim 5, wherein the at least one differential serial communication transmitter of the plurality of differential serial communication transmitters includes:
at least three differential serial communication transmitters to form three corresponding data lanes for communication with the display via the second differential serial communication display link; and
at least one differential serial communication display transmitter to form a corresponding clock lane for communication with the display via the second differential serial communication display link.

8. The differential serial communication transmitter configuration system of claim 5, wherein the at least one differential serial communication transmitter of the plurality of differential serial communication transmitters includes:
at least six differential serial communication transmitters to form six corresponding data lanes for communication with the display via the second differential serial communication display link; and
at least one differential serial communication display transmitter to form a corresponding clock lane for communication with the display via the second differential serial communication display link.

9. The differential serial communication transmitter configuration system of claim 5 including:
a phase-lock loop clock bandwidth and clock mode configuration data register, operatively coupled to the one or more processors, and operative to receive phase-locked loop bandwidth control information and clock mode control information from the one or more processors;
a PCI-E/DVI input selector data register, operatively coupled to the differential serial communication control logic, and operative to receive PCI-E/DVI input selector data from the one or more processors; and
a driver current control data register, operatively coupled to the processor, and operative to receive driver current control data from the one or more processors.

10. The differential serial communication transmitter configuration system of claim 5, wherein the memory contains instructions that cause the one or more processors to:
vary a phase-locked loop (PLL) clock bandwidth to correspond with a phase-locked loop (PLL) clock bandwidth in a differential serial communication display receiver, operatively coupled to the at least one differential serial communication transmitter;
vary a clock mode configuration to correspond with a clock mode configuration in the differential serial communication display receiver;
vary PCI-E/DVI input selector data to receive at least one of: data packets and graphics data packets; and
vary drive current control data of the at least one differential serial communication transmitter to correspond with a current load in a differential serial communication display receiver.

11. A differential serial communication transmitter configuration method comprising:
receiving display configuration control data;
configuring at least three differential serial communication transmitter of a plurality of differential serial communication transmitters to form three corresponding data lanes for communication with a display (i.e. DVI) via a first differential serial communication link, wherein each of the plurality of differential serial communication transmitters is operatively configurable to communicate with a second differential serial communication link; and
configuring at least one of the plurality of differential serial communication transmitters to form a corresponding clock lane for communication with the display via the first differential serial communication link.

12. A differential serial communication transmitter configuration method comprising:
receiving display configuration control data;
configuring at least six differential serial communication transmitter of a plurality of differential serial communication transmitters to form six corresponding data lanes for communication with a display (i.e. DVI) via a first differential serial communication link, wherein each of the plurality of differential serial communication transmitters is operatively configurable to communicate with a second differential serial communication link; and
configuring at least one of the plurality of differential serial communication transmitters to form a corresponding clock lane for communication with the display via the first differential serial communication link.

13. A differential serial communication transmitter configuration method comprising:
receiving display configuration control data;
configuring at least one differential serial communication transmitter of a plurality of differential serial communication transmitters for communication with a display via a first differential serial communication link;
varying a phase-locked loop clock bandwidth to correspond with a phase-locked loop clock bandwidth in a differential serial communication display receiver;
varying a clock mode configuration to correspond with a clock mode configuration in the differential serial communication display receiver;
varying PCI-E/DVI input selector data to receive at least one of: data packets and graphics data packets; and
varying drive current control data and in response varying a current drive level of the at least one differential serial communication transmitter to correspond with a current load in a differential serial communication display receiver,
wherein each of the plurality of differential serial communication transmitters is operatively configurable to communicate with a second differential serial communication link.

14. The method of claim 13 including:
configuring at least three of the plurality of differential serial communication transmitters to form three corresponding data lanes for communication with the display via the first differential serial communication link; and
configuring at least one of the plurality of differential serial communication transmitters to form a corresponding clock lane for communication with the display via the first differential serial communication link.

15. The method of claim 13 including:
configuring at least six of the plurality of differential serial communication transmitters to form six corresponding data lanes for communication with the display via the first differential serial communication link; and
configuring at least one of the plurality of differential serial communication transmitters to form a corresponding clock lane for communication with the display via the first differential serial communication link.

16. Memory containing instructions executable by one or more processing devices that cause the one or more processing devices to:
receive display configuration control data; and
configure at least one differential serial communication transmitter of a plurality of differential serial communication transmitters for communication with a display via a first differential serial communication link wherein each of the plurality of differential serial communication transmitters is operatively configurable to communicate with a second differential serial communication link.

17. The memory of claim 16 containing executable instructions that causes the one or more processors to:
vary a phase-locked loop (PLL) clock bandwidth to correspond with a phase-locked loop (PLL) clock bandwidth in a differential serial communication display receiver; and
vary a clock mode configuration to correspond with a clock mode configuration in the differential serial communication display receiver.

18. A method of operating a differential signal transmitter comprising:
responsive to a first configuration control signal, configuring said differential signal transmitter to output data to interoperate with a first interface; and
responsive to a second configuration control signal, configuring said differential signal transmitter to output data to interoperate with a second interface.

19. The method of claim 18 wherein said first interface comprises a Digital Video Interface (DVI) and wherein said second interface comprises a PCI-express (PCI-e) interface.

20. The method of claim 18 wherein performing said configuring of said differential signal transmitter responsive to said first or second configuration control signals comprises performing said configuring during initialization.

21. The method of claim 18 wherein performing said configuring of said differential signal transmitter responsive to said first or second configuration control signals comprises performing said configuring during a power on condition.

22. The method of claim 18 wherein said configuring of said differential signal transmitter comprises:
varying a clock.

23. The method of claim 22 wherein varying a clock comprises varying a clock frequency.
